(19) United States
(12) Patent Application Publication
(10) Pub. No.: US 2025/0341480 A1
(43) Pub. Date: Nov. 6, 2025

(54) X-RAY MEASUREMENT SYSTEM AND X-RAY MEASUREMENT METHOD

(71) Applicant: NanoSeex Inc., Hsinchu County (TW)

(72) Inventors: YU-YAN AU YONG, Hsinchu County (TW); KAI-HAO CHANG, Hsinchu County (TW); TSUNG-HSIEN HAN, Hsinchu County (TW); CHUN-TING LIU, Hsinchu County (TW); PO-CHING HE, Hsinchu County (TW); PO-TSANG WU, Hsinchu County (TW)

(21) Appl. No.: 19/001,372

(22) Filed: Dec. 24, 2024

(30) Foreign Application Priority Data
May 6, 2024 (TW) 113116631

(51) Int. Cl. G01N 23/20091

(52) U.S. Cl. CPC G01N 23/20091; G01N 2223/052; G01N 2223/1016; G01N 2223/102; G01N 2223/204; G01N 2223/304; G01N 2223/6116

(57) ABSTRACT

An X-ray measurement system and an X-ray measurement method. An optical receiver is used to collect multiple measurement signals generated from reflection of multiple X-ray beams having different energies by an inspection target. Multiple fitting models are established according to a target architecture of the inspection target. A spectrum fitting analysis is performed on the measurement signals respectively by the fitting models, so as to generate multiple to-be-optimized fitting results. The to-be-optimized fitting results are counted to generate multiple parameter fitting ranges. A set of to-be-verified parameters is generated according to the parameter fitting ranges, is input into the fitting models to verify an accuracy thereof, and is adjusted according to the accuracy and the parameter fitting ranges until an optimization condition is satisfied. The set of to-be-verified parameters that satisfies the optimization condition is configured as an optimized fitting result.

### CROSS-REFERENCE TO RELATED PATENT APPLICATION

This application claims the benefit of priority to Taiwan Patent Application No. 113116631, filed on May 6, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an X-ray measurement system and an X-ray measurement method, and more particularly to range measurement of an X-ray wide energy band and a measurement method of a multi-model algorithm.

### BACKGROUND OF THE DISCLOSURE

With a gradual increase in a computation amount of a processor, the requirement on a semiconductor circuit is also more detailed. In order to manufacture a circuit having a precision of below 7 nm, extreme ultraviolet (EUV) having a wavelength of less than 13.5 nm is selected as a mask aligner of a light source. Due to a short wavelength of the EUV, a reflector needs to be disposed on a mask to reflect a circuit pattern onto a wafer. The reflector is made of an overlapping combination of Mo (molybdenum) and Si (silicon), and the quantity of layers is at least about 30 to 40, so as to ensure that an EUV reflectivity is greater than 80%.

Currently, since only a conventional transmission electron microscope (TEM) or a conventional secondary-ion mass spectrometry (SIMS) measurement machine can be used to monitor multi-layer film thickness or other important parameters of an EUV mask, there are disadvantages of being time-consuming, unable to avoid damage to a sample, or only able to perform an analysis on elements of a surface layer. Furthermore, even though techniques of non-destructive testing by use of a light source having a single wavelength are available, inspection of a deeper thickness is not possible due to limitation on an attenuation length by which incident light enters the sample.

Therefore, how to obtain a more precise measurement result by using a non-destructive measurement method, so as to overcome the above-mentioned problems, has become one of the important issues to be solved in the relevant industry.

### SUMMARY OF THE DISCLOSURE

In response to the above-referenced technical inadequacies, the present disclosure provides an X-ray measurement system and an X-ray measurement method.

In order to solve the above-mentioned problems, one of the technical aspects adopted by the present disclosure is to provide an X-ray measurement system, which includes: an X-ray source, an optical receiver, and a processing device. The X-ray source generates a plurality of X-ray beams having different energies, and irradiates an inspection target. The optical receiver collects a plurality of measurement signals generated from reflection of the plurality of X-ray beams by the inspection target. The processing device is configured to execute processes of: establishing a plurality of fitting models according to a target architecture of the inspection target; performing a spectrum fitting analysis on the plurality of measurement signals respectively by the plurality of fitting models, so as to generate a plurality of to-be-optimized fitting results; counting the plurality of to-be-optimized fitting results to generate a plurality of parameter fitting ranges; and generating a set of to-be-verified parameters according to the plurality of parameter fitting ranges, inputting the set of to-be-verified parameters into the plurality of fitting models to verify an accuracy of the set of to-be-verified parameters, adjusting the set of to-be-verified parameters according to the accuracy and the plurality of parameter fitting ranges until an optimization condition is satisfied, and configuring the set of to-be-verified parameters that satisfies the optimization condition as an optimized fitting result.

In order to solve the above-mentioned problems, another one of the technical aspects adopted by the present disclosure is to provide an X-ray measurement method. The X-ray measurement method includes: generating a plurality of X-ray beams having different energies by at least one X-ray source, and irradiating an inspection target; using an optical receiver to collect a plurality of measurement signals generated from reflection of the plurality of X-ray beams by the inspection target; and using a processing device to execute the following processes. The following processes include: establishing a plurality of fitting models according to a target architecture of the inspection target; performing a spectrum fitting analysis on the plurality of measurement signals respectively by the plurality of fitting models, so as to generate a plurality of to-be-optimized fitting results; counting the plurality of to-be-optimized fitting results to generate a plurality of parameter fitting ranges; and generating a set of to-be-verified parameters according to the plurality of parameter fitting ranges, inputting the set of to-be-verified parameters into the plurality of fitting models to verify an accuracy of the set of to-be-verified parameters, adjusting the set of to-be-verified parameters according to the accuracy and the plurality of parameter fitting ranges until an optimization condition is satisfied, and configuring the set of to-be-verified parameters that satisfies the optimization condition as an optimized fitting result.

Therefore, in the X-ray measurement system and the X-ray measurement method provided by the present disclosure, by virtue of “irradiating an inspection target by a plurality of X-ray beams having different energies, and using an optical receiver to collect a plurality of measurement signals generated from reflection of the plurality of X-ray beams by the inspection target,” “establishing a plurality of fitting models according to a target architecture of the inspection target,” “performing a spectrum fitting analysis on the plurality of measurement signals respectively by the plurality of fitting models, so as to generate a plurality of to-be-optimized fitting results,” “counting the plurality of to-be-optimized fitting results to generate a plurality of parameter fitting ranges,” and “generating a set of to-be-verified parameters according to the plurality of parameter fitting ranges, inputting the set of to-be-verified parameters into the plurality of fitting models to verify an accuracy of the set of to-be-verified parameters, adjusting the set of to-be-verified parameters according to the accuracy and the plurality of parameter fitting ranges until an optimization condition is satisfied, and configuring the set of to-be-verified parameters that satisfies the optimization condition as an optimized fitting result,” a standard deviation of parameters of the optimized fitting result can be reduced. That is, an error is decreased.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an X-ray measurement system according to one embodiment of the present disclosure;

FIG. 2 is a schematic view showing the X-ray measurement system having various targets according to one embodiment of the present disclosure;

FIG. 3A and FIG. 3B are each a functional block diagram of an X-ray measurement method according to one embodiment of the present disclosure;

FIG. 4 is a graph showing elements or compounds and their corresponding X-ray energies and depths;

FIG. 5 is a spectral graph showing a first X-ray beam of the X-ray measurement system according to the present disclosure;

FIG. 6 is a spectral graph showing a second X-ray beam of the X-ray measurement system according to the present disclosure;

FIG. 7 is a spectral graph showing a third X-ray beam of the X-ray measurement system according to the present disclosure;

FIG. 8 is a schematic view showing a first fitting model of the X-ray measurement system according to the present disclosure;

FIG. 9 is a schematic view showing a second fitting model of the X-ray measurement system according to the present disclosure; and

FIG. 10 is a schematic view showing a third fitting model of the X-ray measurement system according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

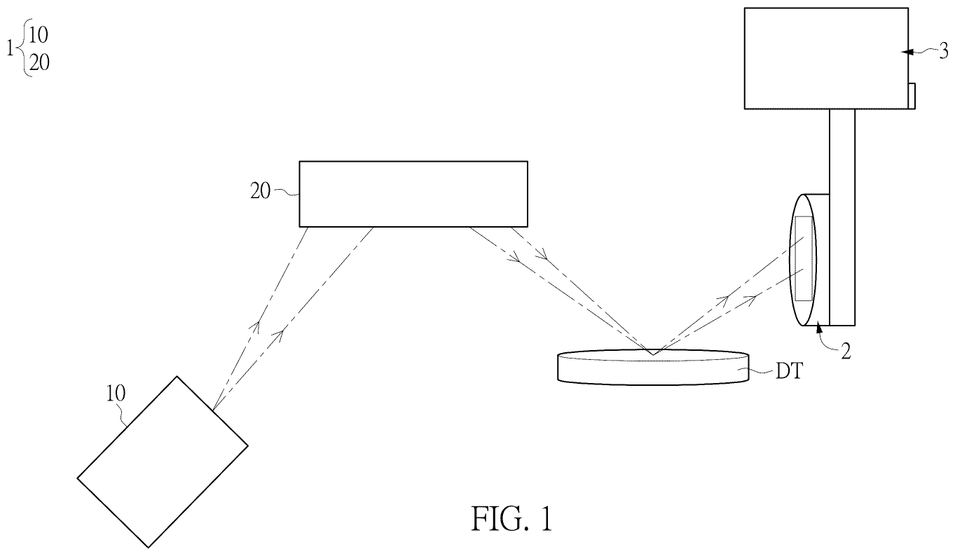

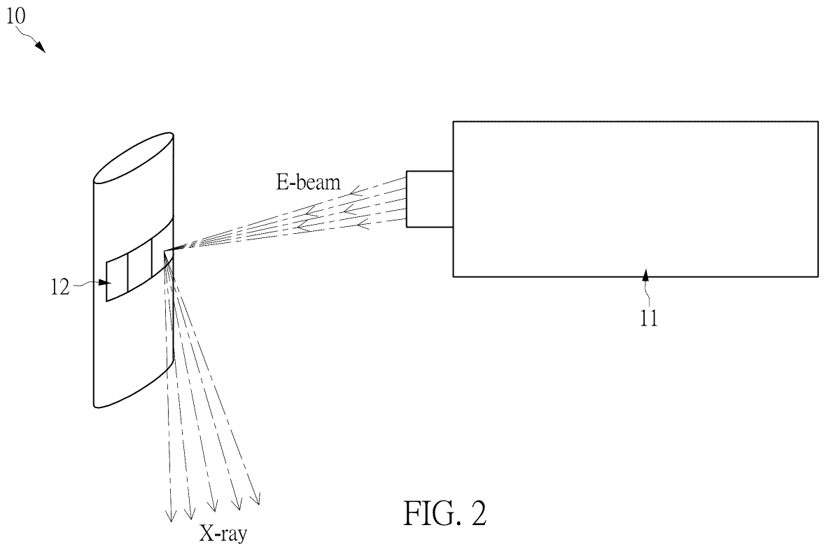

FIG. 1 is a schematic view of an X-ray measurement system according to one embodiment of the present disclosure. FIG. 2 is a schematic view showing the X-ray measurement system having various targets according to one embodiment of the present disclosure. As shown in FIG. 1, one embodiment of the present disclosure provides an X-ray measurement system, which includes an X-ray source 1, an optical receiver 2, and a processing device 3.

The X-ray source 1 is used to generate a plurality of X-ray beams having different energies, and irradiates an inspection target DT. The X-ray source 1 includes an X-ray generator 10 and an X-ray lens assembly 20. For the X-ray source 1, the X-ray beams having different energies are generated by enabling an electron beam to passes through different targets. As shown in FIG. 2, the X-ray generator 10 includes an electron beam generator 11 and a target 12. The electron beam generator 11 emits one electron beam to different targets for generating a plurality of X-ray beams having different wavelengths. Materials of the targets are different from one another, which include copper, molybdenum, silver, or aluminum. The X-ray beams having different wavelengths can include, for example, a first X-ray beam having an energy range of between 90 eV and 94 eV, a second X-ray beam having an energy range of between 1,480 eV and 1,490 eV, and a third X-ray beam having an energy range of between 8,040 eV and 8,900 eV. The X-ray source 1 generates and emits the X-ray beams having different wavelengths to the inspection target DT. The inspection target DT can have a multi-layer structure. For example, the inspection target DT is an extreme ultraviolet (EUV) mask having the multi-layer structure.

Specifically, attenuation lengths of the X-ray beams having different energies vary in response to different materials. As such, for the materials used in the multi-layer structure of the inspection target DT, the X-ray measurement system can inspect the inspection target DT by using X-ray beams having different energy ranges. It should be noted that, when an x-ray having a specific energy irradiates a certain element or compound, the attenuation length refers to a penetration depth that said x-ray having the specific energy can reach as its energy falls to 1/e (only about 1/2.72 of its original intensity remains), and can be used to analyze analysis sensitivity of an X-ray under the specific energy.

In the present embodiment, when the inspection target DT is the EUV mask, the inspection target DT can include, for example, one or more of an inter-diffusion layer, a reflective composite layer, a capping layer (CL), and a low thermal expansion material (LTEM) layer. For example, an X-ray having an energy range of between 90 eV and 94 eV is selected to measure the inter-diffusion layer, an X-ray having an energy range of between 1,480 eV and 1,490 eV is selected to measure the reflective composite layer and the capping layer within the mask, and an X-ray having an energy range of between 8,040 eV and 8,900 eV is selected to measure the low thermal expansion material layer. In the present embodiment, the inter-diffusion layer is an oxide layer generated during formation of the mask, and is rich in light elements, such as molybdenum disilicide (MoSi₂), molybdenum silicide (Mo₅Si₃), or ruthenium oxide (RuO). Measurement of the inter-diffusion layer is suitably performed by using the X-ray having the (lower) energy range of between 90 e V and 94 eV.

On the other hand, the capping layer contains ruthenium and ruthenium compounds. The reflective composite layer includes about forty pairs of repetitive layers. The reflective composite layer is formed by alternating material layers that contain more than two metal elements. For example, the reflective composite layer of the present embodiment includes about 40 molybdenum-silicon (Mo/Si) film pairs, and its measurement is suitably performed by using the X-ray having the energy range of between 1,480 eV and 1,490 e V.

The low thermal expansion material layer is usually disposed at a bottom portion of the EUV mask, and is a multi-layer film having a great thickness. The low thermal expansion material layer contains fused silicon, fused silica, calcium fluoride, silicon carbide, an silicon oxide-titanium oxide alloy, and/or other suitable materials known in the art, and its measurement is suitably performed by using the X-ray having the energy range of between 8,040 eV and 8,900 e V.

After the inspection target DT is irradiated by X-rays having different energies, the optical receiver 2 can collect various measurement signals reflected by the inspection target DT. The processing device 3 includes a plurality of measurement tools, and is used to analyze the various measurement signals. Here, the various measurement signals include reflected light, scattered light, and diffraction light of the X-ray, or fluorescence released from the inspection target DT when being excited by the X-ray. The measurement tools include an X-ray reflectivity (XRR) analyzer, an X-ray fluorescence (XRF) spectrometer, a small-angle X-ray scattering (SAXS) analyzer, an X-ray diffractometer (XRD), or other apparatuses that are capable of using the X-ray as a light source for measurement. The X-ray measurement system of the present disclosure can analyze the various measurement signals collected from the inspection target DT, and the measurement signals and the measurement tools are not limited to those mentioned above. Specifically, when the measurement signal is the reflected light, the optical receiver 2 of the X-ray measurement system can be a reflected light receiver, the measurement tool can be the X-ray reflectivity analyzer, and the reflected light of the X-ray is reflected by the inspection target DT for analysis. When the measurement signal is the fluorescence and the inspection target DT is irradiated by the X-ray, an inner orbital electron within the inspection target DT will be excited by the X-ray. At this time, an electron at a high energy level jumps to where an electron having a low band gap is located, such that a gap generated by the excited electron is filled, and a corresponding energy is released (i.e., corresponding fluorescence is emitted). The optical receiver 2 is a fluorescence receiver, and the measurement tool is the X-ray fluorescence spectrometer that analyzes the collected fluorescence to obtain a spectrum of the fluorescence. When the measurement signal is the scattered light, the optical receiver 2 is a scattered light receiver, and the measurement tool is the small-angle X-ray scattering analyzer that performs a small-angle X-ray scattering analysis. When the measurement signal is the diffraction light, the optical receiver 2 is a diffraction light receiver, and the measurement tool is the X-ray diffractometer that collects the diffraction light generated by the inspection target DT for analysis.

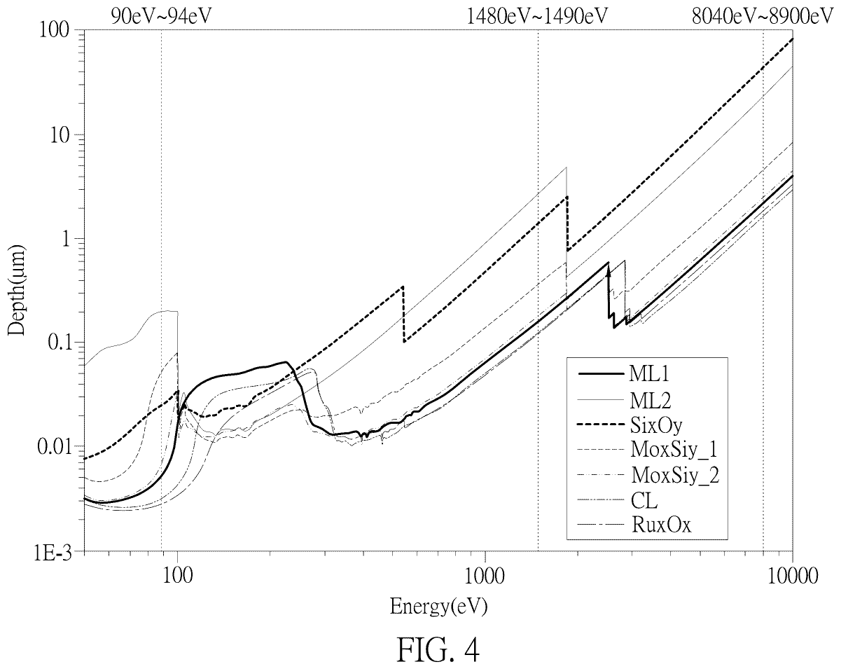

FIG. 4 is a graph showing elements or compounds and their corresponding X-ray energies and depths. As shown in FIG. 4, each measurement signal is a reflection pattern that is generated by using the optical receiver 2 to collect irradiation of each X-ray beam on the inspection target DT from a plurality of different incident angles. The X-axis represents an X-ray energy, and the Y-axis represents an X-ray penetration depth. After the X-ray beam penetrates the EUV mask and is emitted to each layer structure, the X-ray energy passes through different elements or compounds, thereby causing a decrease in the X-ray energy (i.e., only about 0.367 times its original intensity remains). The X-ray beams having different energy ranges differ from one another in terms of optical sensitivity to a material layer, and can thus be used to analyze analysis sensitivity of such light source energy.

In the present disclosure, the processing device 3 can be a general processor, a computer, other unique hardware devices with a specific logic circuit, or other apparatuses having a specific function. The processing device 3 of the present embodiment can further include an electromagnetic wave computation engine. The electromagnetic wave computation engine is an algorithm that is implemented by computer-related hardware devices. The electromagnetic wave computation engine includes a finite-difference time-domain (FDTD) method, a distorted wave born approximation (DWBA) method, a rigorous coupled wave analysis (RCWA), a discrete dipole approximation (DDA) method, a boundary element method (BEM), etc.

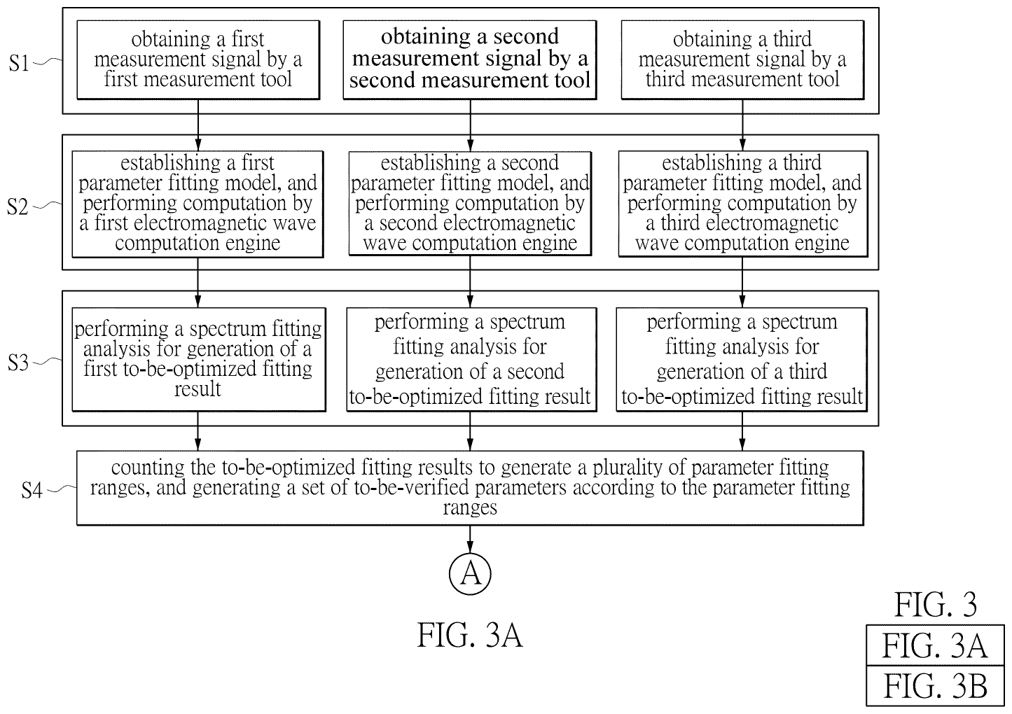

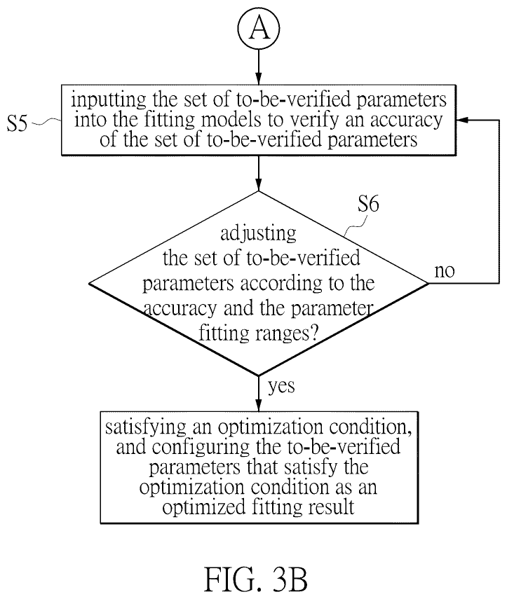

FIG. 3A and FIG. 3B are each a functional block diagram of an X-ray measurement method according to one embodiment of the present disclosure. As shown in FIG. 3A and FIG. 3B, this measurement method includes using data measured by X-ray beams having different energy bands in a multi-model computation algorithm to obtain a plurality of structural parameters of a target architecture TS. As mentioned previously, the inspection target DT is the EUV mask having the multi-layer structure. The target architecture TS can include a plurality of material layers that are designed according to the structure of the inspection target DT, and the structural parameters can include, for example, a thickness, a density, or a roughness of each material layer.

Computation processing performed by the processing device 3 includes the following steps.
Step S1: obtaining the measurement signals by the measurement tools. Step S1 further includes step S11 and step S12.
Step S11: generating the X-ray beams having different energies by more than one X-ray source, and irradiating the inspection target DT.
Step S12: using the optical receiver 2 to collect the measurement signals generated from reflection of the X-ray beams by the inspection target DT.

Step S11 and step S12 are further illustrated. The measurement signals of the present embodiment include a first measurement signal SP1, a second measurement signal SP2, and a third measurement signal SP3. For example, the first X-ray beam having the energy range of between 90 eV and 94 eV measures a mask test piece by a first measurement tool for obtaining and computing the obtained first measurement signal SP1, the second X-ray beam having the energy range of between 1,480 eV and 1,490 eV measures the mask test piece by a second measurement tool for obtaining and computing the obtained second measurement signal SP2, and the third X-ray beam having the energy range of between 8,040 eV and 8,900 eV measures the mask test piece by a third measurement tool for obtaining and computing the obtained third measurement signal SP3. The quantity of the measurement tools is not limited in the present embodiment. It should be noted that the first measurement tool, the second measurement tool, and the third measurement tool used in this step can each include the configuration of the X-ray source 1 and the optical receiver 2 mentioned above, and their difference resides in use of different X-ray energies. The quantity of the first measurement tool, the second measurement tool, and the third measurement tool is only an example here. In addition, each of the first measurement tool, the second measurement tool, and the third measurement tool can be the X-ray reflectivity analyzer, the X-ray fluorescence spectrometer, the small-angle X-ray scattering analyzer, the X-ray diffractometer, or other apparatuses that are capable of using the X-ray as a light source for measurement.

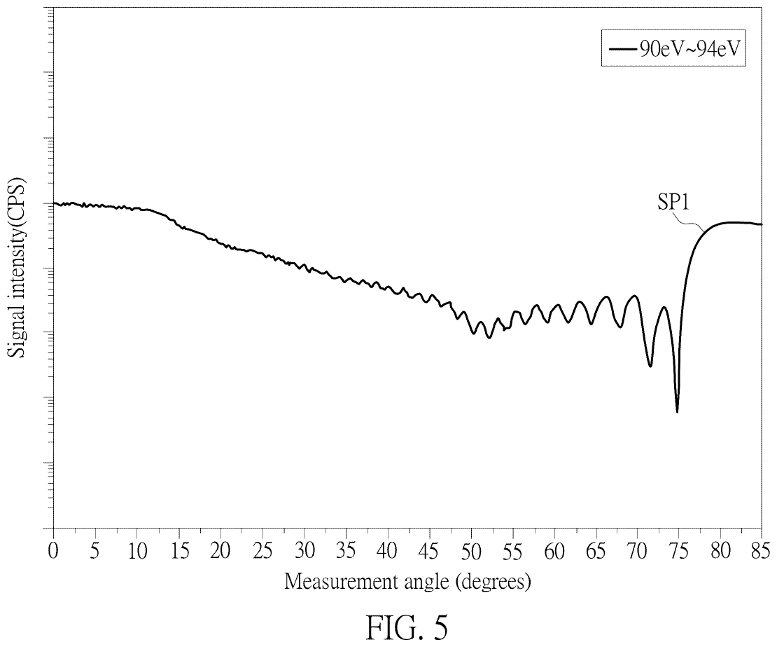

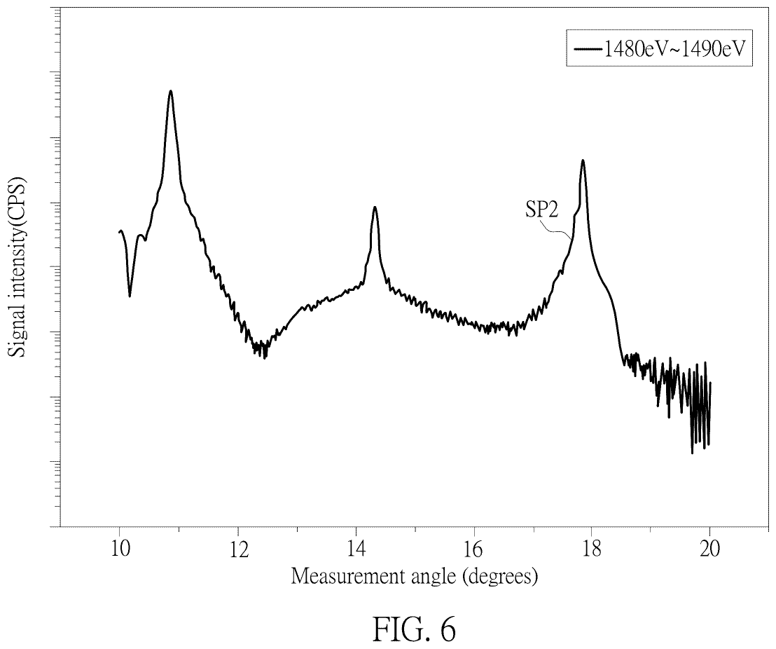

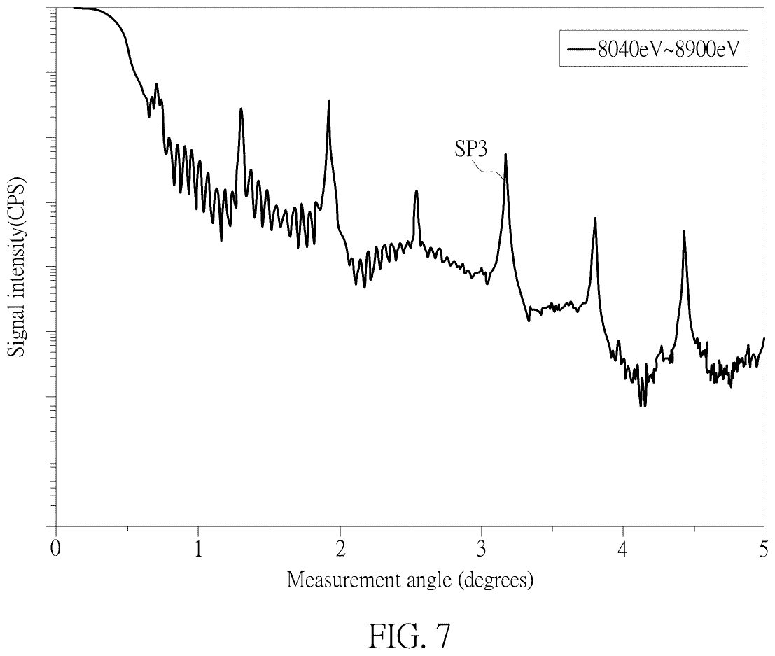

FIG. 5 is a spectral graph showing a first X-ray beam of the X-ray measurement system according to the present disclosure. FIG. 6 is a spectral graph showing a second X-ray beam of the X-ray measurement system according to the present disclosure. FIG. 7 is a spectral graph showing a third X-ray beam of the X-ray measurement system according to the present disclosure.

FIG. 5 to FIG. 7 show measurement signals obtained by measuring the mask test piece with three X-ray beams having different energies. In FIG. 5 to FIG. 7, the X-axis represents a measurement angle, and its unit is degrees. The Y-axis represents an intensity of a collected X-ray measurement signal, and its unit is a count value that is generated after integration of photons received by an optical receiver within each second (i.e., counts per second (CPS)). The measurement signals of FIG. 5 to FIG. 7 are collected after irradiating and measuring the mask test piece with the X-ray beams having different energies. The measurement signals include first data collected after irradiation of the first X-ray beam, second data collected after irradiation of the second X-ray beam, and third data collected after irradiation of the third X-ray beam. The processing device 3 can compute and obtain the structural parameters (which include the thickness, the density, and the roughness) of each material layer according to properties of a measured spectral curve. The properties of the spectral curve include a curve slope or a specific peak pitch. The spectral curves in FIG. 5 to FIG. 7 are different from one another. That is, for the X-ray beams having different energy ranges, the obtained thickness, density, or roughness of each material layer is also different.
Step S2: establishing a plurality of fitting models according to the target architecture of an inspection target, and performing computation by an electromagnetic wave computation engine of a corresponding measurement tool.

The processing device 3 establishes a plurality of fitting models FM according to the target architecture TS of the inspection target DT. In addition, the processing device 3 operates the electromagnetic wave computation engine that corresponds to each fitting model FM, and performs a spectrum fitting analysis on a corresponding one of the measurement signals according to the target architecture TS, so as to obtain a corresponding to-be-optimized fitting result. For example, in the present embodiment, a first parameter fitting model FM1 and a first electromagnetic wave computation engine EM1 both correspond to the first measurement tool, a second parameter fitting model FM2 and a second electromagnetic wave computation engine EM2 both correspond to the second measurement tool, and a third parameter fitting model FM3 and a third electromagnetic wave computation engine EM3 both correspond to the third measurement tool.

According to importance of each material layer, changes in process conditions, or other factors, different computation modes can be carried out in each material layer during model establishment, thereby establishing the fitting model. The processing device 3 operates the electromagnetic wave computation engine that corresponds to each fitting model, and performs the spectrum fitting analysis on a corresponding one of the measurement signals according to the target architecture TS, so as to obtain a corresponding to-be-optimized fitting result. In the present disclosure, a plurality of binding computation modes are provided. The binding computation modes include division of the material layers of the target architecture TS into one or more computation sets. Each computation set is an independent computation set or a binding computation set, and the electromagnetic wave computation engine performs the spectrum fitting analysis on the measurement signals according to the one or more computation sets.

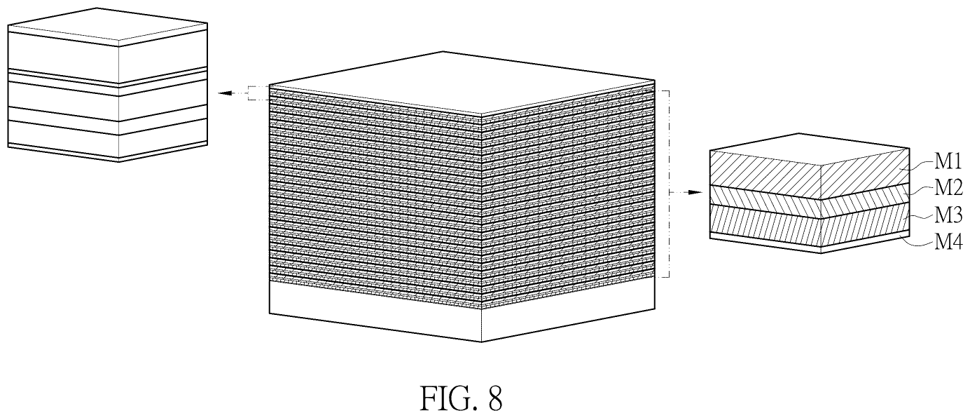

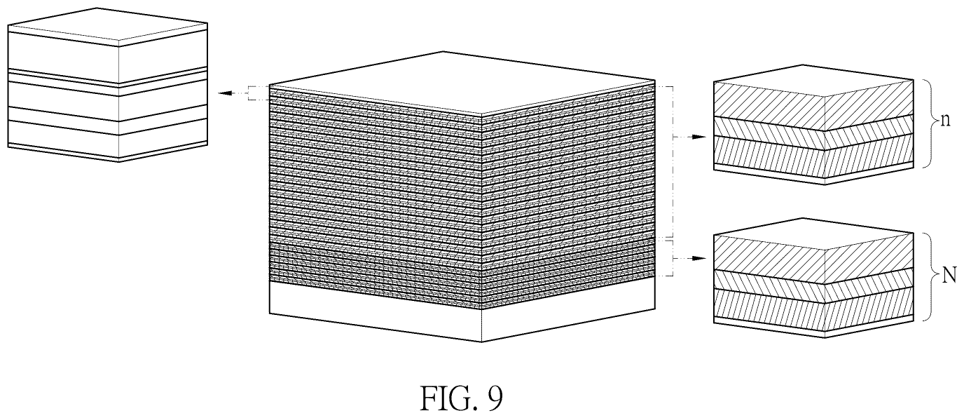

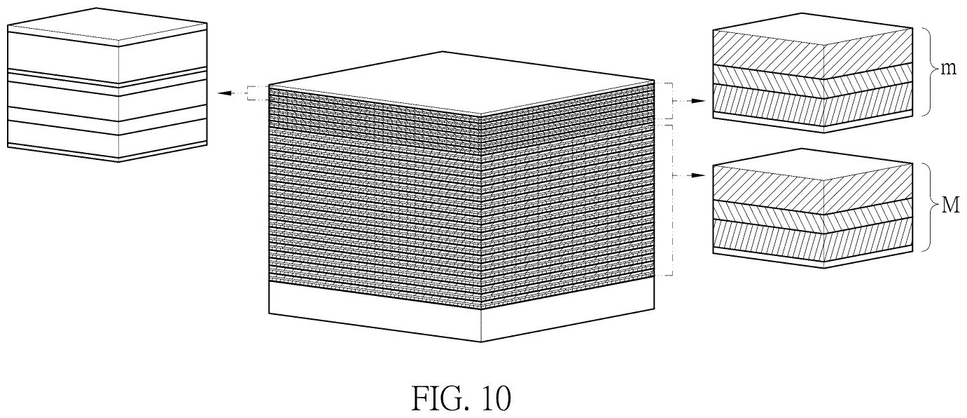

Three fitting model configurations will be illustrated below. FIG. 8 is a schematic view showing a first fitting model of the X-ray measurement system according to the present disclosure. FIG. 9 is a schematic view showing a second fitting model of the X-ray measurement system according to the present disclosure. FIG. 10 is a schematic view showing a third fitting model of the X-ray measurement system according to the present disclosure. Referring to FIG. 8 to FIG. 10, the X-ray measurement system of the present embodiment includes a first fitting model, a second fitting model, and a third fitting model. As shown in FIG. 8, each material layer in the first fitting model is configured as the independent computation set. Since the electromagnetic wave computation engine is used for computation of each material layer in the first fitting model, the first fitting model of the three fitting model configurations consumes the most time and computation amount. As shown in FIG. 9, the material layers in the second fitting model are divided into an n number of the independent computation sets and an N number of the binding computation sets, and n is greater than N. As shown in FIG. 10, the material layers in the third fitting model are divided into an m number of the independent computation sets and an M number of the binding computation sets, and m is less than M. Here, the n independent computation sets and the m independent computation sets each include at least four (M1, M2, M3, M4) of the material layers. In the present disclosure, the first parameter fitting model FM1, the second parameter fitting model FM2, and the third parameter fitting model FM3 can select a different configuration of the fitting model according to whether or not parameters of the material layers are a key process. In this way, redundant computation can be reduced, computation time can be shortened, and a measurement accuracy can be improved.
Step S3: performing the spectrum fitting analysis on the measurement signals respectively by the fitting models, so as to generate multiple ones of the to-be-optimized fitting result.

The to-be-optimized fitting results include a plurality of first structural parameters for describing the material layers, and a plurality of first errors COSTX₁ to COSTXₙ (in which COST stands for calibration optimization with a standard technique) and a plurality of first variances Δp₁ to Δpₙ that respectively correspond to the first structural parameters.

Specifically, the electromagnetic wave computation engine stored in the processing device 3 performs the spectrum fitting analysis on a corresponding one of the measurement signals, so as to generate the to-be-optimized fitting result. As shown in FIG. 3A and FIG. 3B, the processing device 3 establishes the first parameter fitting model FM1, and the first electromagnetic wave computation engine EM1 that corresponds to the first parameter fitting model FM1 performs the spectrum fitting analysis on the first measurement signal SP1 for generation of a first to-be-optimized fitting result. The second electromagnetic wave computation engine EM2 that corresponds to the second parameter fitting model FM2 performs the spectrum fitting analysis on the second measurement signal SP2 for generation of a second to-be-optimized fitting result. The third electromagnetic wave computation engine EM3 that corresponds to the third parameter fitting model FM3 performs the spectrum fitting analysis on the third measurement signal SP3 for generation of a third to-be-optimized fitting result.

In continuation of the above, measurement data can also be obtained by an N number of measurement machines in the present disclosure. After establishment of a corresponding fitting model, the measurement signals are subjected to a fitting analysis via an N number of parameter fitting models, respectively. Through an N number of corresponding electromagnetic wave computations, the first errors COSTX₁ to COSTXₙ and the first variances Δp₁ to Δpₙ that respectively correspond to the first structural parameters are generated. A plurality of first errors and a plurality of first variances are the first to-be-optimized fitting result, and an error can be a value of calibration optimization with a standard technique. However, the present disclosure is not limited to the example mentioned above.

For example, the target architecture TS includes six material layers, which are a first material layer ML1, a second material layer ML2, a third material layer ML3, a fourth material layer ML4, a fifth material layer ML5, and a sixth material layer ML6. After the first electromagnetic wave computation engine EM1 that corresponds to the first parameter fitting model FM1 performs the spectrum fitting analysis on the first measurement signal SP1, a value of a thickness of each material layer in the target architecture TS can be obtained as ML1, ML2, ML3, ML4, ML5, ML6: 20, 20, 20, 20, 20, 20. After the second electromagnetic wave computation engine EM2 that corresponds to the second parameter fitting model FM2 performs the spectrum fitting analysis on the second measurement signal SP2, the value of the thickness of each material layer in the target architecture TS can be obtained as ML1, ML2, ML3, ML4, ML5, ML6: 60, 40, 60, 40, 60, 40. Since the data above is counted and analyzed only by use of sequences, a unit of the thickness is not listed. The above-mentioned two sequences for the thickness of each material layer (which are generated by the fitting analysis) are two to-be-optimized fitting results. The quantity of the material layers in the present embodiment is not limited to six, and values generated after the spectrum fitting analysis are not limited to the thickness of each material layer.
Step S4: counting the to-be-optimized fitting results to generate a plurality of parameter fitting ranges, and generating a set of to-be-verified parameters according to the parameter fitting ranges.

The set of to-be-verified parameters includes a plurality of second structural parameters for describing each material layer. In addition, the X-ray measurement method further includes: randomly generating the set of to-be-verified parameters according to the parameter fitting ranges; inputting the set of to-be-verified parameters into the fitting models after an interactive combination of the set of to-be-verified parameters is performed, so as to verify an accuracy of the set of to-be-verified parameters; and adjusting the set of to-be-verified parameters after another interactive combination of the set of to-be-verified parameters is performed according to the accuracy and the parameter fitting ranges.

In continuation of the example in step S3, the two sequences for the thickness of each material layer are counted to generate a fitting range (i.e., the parameter fitting range) for the thickness of each material layer. For example, a thickness range of the first material layer ML1 ranges between 20 and 60, a thickness range of the second material layer ML2 ranges between 20 and 40, a thickness range of the third material layer ML3 ranges between 20 and 60, a thickness range of the fourth material layer ML4 ranges between 20 and 40, a thickness range of the fifth material layer ML5 ranges between 20 and 60, and a thickness range of the sixth material layer ML6 ranges between 20 and 40.

Then, the set of to-be-verified parameters is generated according to these parameter fitting ranges. Within the fitting range for the thickness of each material layer, different permutations and combinations of the thickness are generated from random numbers. For example, generation of the set of to-be-verified parameters includes the two sequences, and each value in each sequence is selected from the parameter fitting range of each material layer. Specifically, a first value in a first sequence is randomly generated from the thickness range of the first material layer ML1. That is to say, the first value is randomly generated from a range of between 20 and 60. A second value in the first sequence is randomly generated from the thickness range (i.e., a value range of between 20 and 40) of the second material layer ML2. On this basis, a sixth value in the first sequence is randomly generated from the thickness range (i.e., a value range of between 20 and 40) of the sixth material layer ML6. Similarly, each value in a second sequence is randomly generated from a sequential one of the thickness ranges of the first material layer ML1 to the sixth material layer ML6. The first sequence and the second sequence form the set of to-be-verified parameters. In other words, one set of to-be-verified parameters at least includes two sequences for an interactive combination. However, the quantity of the sequences in the present disclosure is not limited to two.
Step S5: inputting the set of to-be-verified parameters into the fitting models to verify the accuracy of the set of to-be-verified parameters.

The set of to-be-verified parameters is input into the fitting models after the interactive combination of the set of to-be-verified parameters is performed, so as to verify its accuracy. For example, this set of to-be-verified parameters includes the first sequence and the second sequence. An N number of values are randomly selected from the first sequence, and are exchanged with corresponding values in the second sequence, thereby obtaining a third sequence and a fourth sequence. For example, in order to obtain the third sequence and the fourth sequence, the values of the first material layer ML1 to the third material layer ML3 are randomly selected from the first sequence, and are exchanged with the values of the first material layer ML1 to the third material layer ML3 in the second sequence. That is to say, the third sequence and the fourth sequence are different from the first sequence and the second sequence. Then, the third sequence and the fourth sequence are input into the fitting models to verify accuracies of the third sequence and the fourth sequence.

The process of verifying the accuracy of the set of to-be-verified parameters includes: inputting the set of to-be-verified parameters into the fitting models to generate a plurality of to-be-verified fitting results and a plurality of second errors COSTX′₁ to COSTX′ₙ and a plurality of second variances Δp′₁ to Δp′ₙ that correspond to the to-be-verified fitting results; comparing the second errors COSTX′₁ to COSTX′ₙ with the first errors COSTX₁ to COSTXₙ, respectively; and comparing the second variances Δp′₁ to Δp′ₙ with the first variances Δp₁ to Δpₙ, respectively.
Step S6: adjusting the set of to-be-verified parameters according to the accuracy and the parameter fitting ranges.

Based on a comparison result, whether or not an optimization condition is satisfied can be confirmed. If the optimization condition is satisfied, the set of to-be-verified parameters is configured as an optimized fitting result. If the optimization condition is not satisfied, the set of to-be-verified parameters is adjusted after another interactive combination of the set of to-be-verified parameters is performed according to the accuracy and the parameter fitting ranges.

The situation that satisfies the optimization condition is described as follows. In response to detecting that the second errors COSTX′₁ to COSTX′ₙ are respectively less than the first errors COSTX₁ to COSTXₙ and the second variances Δp′₁ to Δp′ₙ are respectively less than the first variances Δp₁ to Δpₙ, the optimization condition is determined to be satisfied.

The optimization condition is not satisfied when the second errors COSTX′₁ to COSTX′ₙ are respectively greater than the first errors COSTX₁ to COSTXₙ and the second variances Δp′₁ to Δp′ₙ are respectively greater than the first variances Δp₁ to Δpₙ. In response to determining that the optimization condition is not satisfied, the set of to-be-verified parameters is adjusted according to the parameter fitting ranges, and an accuracy of the adjusted set of to-be-verified parameters is determined. After the result of variance reduction is obtained, it can be confirmed that values of calibration optimization (COSTX′₁, COSTX′₂, . . . COSTX′ₙ) and fitting variances (Δp′₁, Δp′₂, . . . Δpₙ) can be less than those without being in a loop process.

### Beneficial Effects of the Embodiments

In conclusion, in the X-ray measurement system and the X-ray measurement method provided by the present disclosure, by virtue of “irradiating an inspection target by a plurality of X-ray beams having different energies, and using an optical receiver to collect a plurality of measurement signals generated from reflection of the plurality of X-ray beams by the inspection target,” “establishing a plurality of fitting models according to a target architecture of the inspection target,” “performing a spectrum fitting analysis on the plurality of measurement signals respectively by the plurality of fitting models,” and “generating to-be-verified parameters according to a fitting analysis result, verifying an accuracy of the to-be-verified parameters, adjusting the to-be-verified parameters according to the accuracy until an optimization condition is satisfied, and obtaining an optimized fitting result,” a standard deviation of parameters of the optimized fitting result can be reduced. That is, the error is decreased.

Furthermore, in the X-ray measurement system and the X-ray measurement method provided by the present disclosure, a different configuration of the fitting model can be selected according to whether or not the parameters of the material layers are a key process. In this way, redundant computation can be reduced, computation time can be shortened, and a measurement accuracy can be improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An X-ray measurement method, comprising:
generating a plurality of X-ray beams having different energies by at least one X-ray source, and irradiating an inspection target;
using an optical receiver to collect a plurality of measurement signals generated from reflection of the plurality of X-ray beams by the inspection target; and
using a processing device to execute processes of:
establishing a plurality of fitting models according to a target architecture of the inspection target;
performing a spectrum fitting analysis on the plurality of measurement signals respectively by the plurality of fitting models, so as to generate a plurality of to-be-optimized fitting results;
counting the plurality of to-be-optimized fitting results to generate a plurality of parameter fitting ranges; and
generating a set of to-be-verified parameters according to the plurality of parameter fitting ranges, inputting the set of to-be-verified parameters into the plurality of fitting models to verify an accuracy of the set of to-be-verified parameters, adjusting the set of to-be-verified parameters according to the accuracy and the plurality of parameter fitting ranges until an optimization condition is satisfied, and configuring the set of to-be-verified parameters that satisfies the optimization condition as an optimized fitting result.

2. The X-ray measurement method according to claim 1, wherein each of the plurality of measurement signals is a reflection pattern that is generated by using the optical receiver to collect irradiation of each of the plurality of X-ray beams on the inspection target from a plurality of different incident angles.

3. The X-ray measurement method according to claim 2, wherein the plurality of X-ray beams include a first X-ray beam having an energy range of between 90 eV and 94 eV, a second X-ray beam having an energy range of between 1,480 eV and 1,490 eV, and a third X-ray beam having an energy range of between 8,040 eV and 8,900 eV.

4. The X-ray measurement method according to claim 2, wherein the target architecture includes a plurality of material layers; wherein the processing device operates an electromagnetic wave computation engine that corresponds to each of the plurality of fitting models, and performs the spectrum fitting analysis on a corresponding one of the plurality of measurement signals according to the target architecture, so as to obtain a corresponding one of the plurality of to-be-optimized fitting results.

5. The X-ray measurement method according to claim 4, wherein the process of performing the spectrum fitting analysis by operation of the electromagnetic wave computation engine further includes: dividing the plurality of material layers of the target architecture into one or more computation sets; wherein each of the one or more computation sets is an independent computation set or a binding computation set, and the electromagnetic wave computation engine performs the spectrum fitting analysis on the plurality of measurement signals according to the one or more computation sets.

6. The X-ray measurement method according to claim 5, wherein, in a first fitting model of the plurality of fitting models, each of the plurality of material layers is configured as the independent computation set;
wherein, in a second fitting model of the plurality of fitting models, the plurality of material layers are divided into an n number of the independent computation sets and an N number of the binding computation sets, and n is greater than N;
wherein, in a third fitting model of the plurality of fitting models, the plurality of material layers are divided into an m number of the independent computation sets and an M number of the binding computation sets, and m is less than M.

7. The X-ray measurement method according to claim 6, wherein the n independent computation sets and the m independent computation sets each include at least four of the plurality of material layers.

8. The X-ray measurement method according to claim 6, wherein the plurality of to-be-optimized fitting results include a plurality of first structural parameters for describing the plurality of material layers, and a plurality of first errors and a plurality of first variances that respectively correspond to the plurality of first structural parameters.

9. The X-ray measurement method according to claim 8, wherein the set of to-be-verified parameters includes a plurality of second structural parameters for describing each of the plurality of material layers, and the X-ray measurement method further comprises:
randomly generating the set of to-be-verified parameters according to the plurality of parameter fitting ranges; inputting the set of to-be-verified parameters into the plurality of fitting models after an interactive combination of the set of to-be-verified parameters is performed, so as to verify the accuracy of the set of to-be-verified parameters; and adjusting the set of to-be-verified parameters after another interactive combination of the set of to-be-verified parameters is performed according to the accuracy and the plurality of parameter fitting ranges.

10. The X-ray measurement method according to claim 9, wherein the process of verifying the accuracy of the set of to-be-verified parameters includes:
inputting the set of to-be-verified parameters into the plurality of fitting models to generate a plurality of to-be-verified fitting results and a plurality of second errors and a plurality of second variances that correspond to the plurality of to-be-verified fitting results; comparing the plurality of second errors with the plurality of first errors, respectively; and comparing the plurality of second variances with the plurality of first variances, respectively.

11. The X-ray measurement method according to claim 10, wherein, in response to detecting that the plurality of second errors are respectively less than the plurality of first errors and the plurality of second variances are respectively less than the plurality of first variances, the optimization condition is determined to be satisfied;
wherein, in response to determining that the optimization condition is not satisfied, the set of to-be-verified parameters is adjusted according to the plurality of parameter fitting ranges, and an accuracy of the adjusted set of to-be-verified parameters is determined.

12. An X-ray measurement system, comprising:
an X-ray source, wherein the X-ray source generates a plurality of X-ray beams having different energies, and irradiates an inspection target;
an optical receiver, wherein the optical receiver collects a plurality of measurement signals generated from reflection of the plurality of X-ray beams by the inspection target; and
a processing device configured to execute processes of:
establishing a plurality of fitting models according to a target architecture of the inspection target;
performing a spectrum fitting analysis on the plurality of measurement signals respectively by the plurality of fitting models, so as to generate a plurality of to-be-optimized fitting results;
counting the plurality of to-be-optimized fitting results to generate a plurality of parameter fitting ranges; and
generating a set of to-be-verified parameters according to the plurality of parameter fitting ranges, inputting the set of to-be-verified parameters into the plurality of fitting models to verify an accuracy of the set of to-be-verified parameters, adjusting the set of to-be-verified parameters according to the accuracy and the plurality of parameter fitting ranges until an optimization condition is satisfied, and configuring the set of to-be-verified parameters that satisfies the optimization condition as an optimized fitting result.

13. The X-ray measurement system according to claim 12, wherein each of the plurality of measurement signals is a reflection pattern that is generated by using the optical receiver to collect irradiation of each of the plurality of X-ray beams on the inspection target from a plurality of different incident angles.

14. The X-ray measurement system according to claim 13, wherein the plurality of X-ray beams are respectively a first X-ray beam having an energy range of between 90 eV and 94 eV, a second X-ray beam having an energy range of between 1,480 eV and 1,490 eV, and a third X-ray beam having an energy range of between 8,040 eV and 8,900 eV.

15. The X-ray measurement system according to claim 13, wherein the target architecture includes a plurality of material layers; wherein the processing device operates an electromagnetic wave computation engine that corresponds to each of the plurality of fitting models, and performs the spectrum fitting analysis on a corresponding one of the plurality of measurement signals according to the target architecture, so as to obtain a corresponding one of the plurality of to-be-optimized fitting results.

16. The X-ray measurement system according to claim 15, wherein the process of performing the spectrum fitting analysis by operation of the electromagnetic wave computation engine further includes: dividing the plurality of material layers of the target architecture into one or more computation sets; wherein each of the one or more computation sets is an independent computation set or a binding computation set, and the electromagnetic wave computation engine performs the spectrum fitting analysis on the plurality of measurement signals according to the one or more computation sets.

17. The X-ray measurement system according to claim 16, wherein, in a first fitting model of the plurality of fitting models, each of the plurality of material layers is configured as the independent computation set;
wherein, in a second fitting model of the plurality of fitting models, the plurality of material layers are divided into an n number of the independent computation sets and an N number of the binding computation sets, and n is greater than N;
wherein, in a third fitting model of the plurality of fitting models, the plurality of material layers are divided into an m number of the independent computation sets and an M number of the binding computation sets, and m is less than M.

18. The X-ray measurement system according to claim 17, wherein the n independent computation sets and the m independent computation sets each include at least four of the plurality of material layers.

19. The X-ray measurement system according to claim 17, wherein the plurality of to-be-optimized fitting results include a plurality of first structural parameters for describing the plurality of material layers, and a plurality of first errors and a plurality of first variances that respectively correspond to the plurality of first structural parameters.

20. The X-ray measurement system according to claim 19, wherein the set of to-be-verified parameters includes a plurality of second structural parameters for describing each of the plurality of material layers, and the processing device is further configured to:
randomly generate the set of to-be-verified parameters according to the plurality of parameter fitting ranges; input the set of to-be-verified parameters into the plurality of fitting models after an interactive combination of the set of to-be-verified parameters is performed, so as to verify the accuracy of the set of to-be-verified parameters; and adjust the set of to-be-verified parameters after another interactive combination of the set of to-be-verified parameters is performed according to the accuracy and the plurality of parameter fitting ranges.

21. The X-ray measurement system according to claim 20, wherein the process of verifying the accuracy of the set of to-be-verified parameters includes:
inputting the set of to-be-verified parameters into the plurality of fitting models to generate a plurality of to-be-verified fitting results and a plurality of second errors and a plurality of second variances that correspond to the plurality of to-be-verified fitting results; comparing the plurality of second errors with the plurality of first errors, respectively; and comparing the plurality of second variances with the plurality of first variances, respectively.

22. The X-ray measurement system according to claim 21, wherein, in response to detecting that the plurality of second errors are respectively less than the plurality of first errors and the plurality of second variances are respectively less than the plurality of first variances, the optimization condition is determined to be satisfied;
wherein, in response to determining that the optimization condition is not satisfied, the set of to-be-verified parameters is adjusted according to the plurality of parameter fitting ranges, and an accuracy of the adjusted set of to-be-verified parameters is determined.
